(19) United States
(12) Patent Application Publication
(10) Pub. No.: US 2019/0070559 A1
(43) Pub. Date: Mar. 7, 2019

(54) HOUSEHOLD WATER PURIFICATION SYSTEM

(71) Applicant: 3M INNOVATIVE PROPERTIES COMPANY, St. Paul, MN (US)

(72) Inventor: Biyong Qiu, Shanghai (CN)

(21) Appl. No.: 16/079,659

(22) PCT Filed: Apr. 11, 2017
(86) PCT No.: PCT/US2017/026946

§ 371 Date: Aug. 24, 2018

(30) Foreign Application Priority Data
Apr. 11, 2016 (CN) 2016202955168

(51) Int. Cl. B01D 61/04; B01D 61/10; C02F 1/00; C02F 1/44

(52) U.S. Cl. CPC B01D 61/04; B01D 61/10; C02F 1/008; C02F 1/441; C02F 2301/043; B01D 2313/18; B01D 2313/50; C02F 2209/03; B01D 2311/04

(57) ABSTRACT

A household water purification system provided in the present model mainly includes: a pre-filter; a reverse osmosis membrane filter element; a first one-way valve and a second one-way valve; a switching device, used for connecting or disconnecting a water path between a water outlet of the pre-filter and a water inlet of the reverse osmosis membrane filter element; a water storage tank, having a first cavity used for accommodating pure water and a second cavity used for accommodating tap water treated by the pre-filter; a water tap, having a water inlet communicating with a water outlet of the second one-way valve through a water path; and a mechanical automatic reversing valve, used for connecting a water path between a second port and a fourth port and meanwhile disconnecting a water path between a third port and the fourth port; or disconnecting a water path between a second port and a fourth port and meanwhile connecting a water path between a third port and the fourth port according to a change in pressure of a first port of the mechanical automatic reversing valve. The household water purification system provided in the present model not only can reduce equipment costs, fault rate, and safety risk, but also can improve use comfort of a user.

### TECHNICAL FIELD

The present model relates to the field of household water purifiers, and in particular, to a household water purification system.

### BACKGROUND

Due to the risk of secondary pollution during transportation of municipally supplied tap water, household water purifiers gradually enter into the life of ordinary people. Existing water purifiers mainly consist of various filtering media having different properties and cylinders. The filtering media are used for removing various impurities or contaminants in tap water, and the cylinder parts are used for accommodating the filtering media and connecting the filtering media to municipal water supply pipelines.

Due to the difference in water conditions, municipal water supply varies from area to area in water quality, for example, the average water hardness in the northern area is higher than that in the mid-eastern area, and the average water hardness in the mid-eastern area is higher than that in the southern area. Generally speaking, the phenomenon of incrustation after heating of drinking water is common in areas having high water hardness. In order to solve the problem of incrustation, most of water purifier manufacturers use a reverse osmosis membrane filtration technology to manufacture household water purification systems.

A small household water purification system cannot meet a user's water demand if used directly due to a small seepage flow of a membrane element thereof, and thus uses a water storage tank to store pure water, and pure water discharged when the user turns on a water tap actually comes from the water storage tank. The water storage tank has two cavities isolated by a diaphragm (elastic diaphragm). One cavity is used for storing pure water and the other cavity stores compressed air, the compressed air has a certain pressure, and the compressed air presses against the cavity storing the pure water by means of the diaphragm to force the pure water out of the water tap when the user turns on the water tap. When there is no pure water in the water storage tank, the compressed air has the largest volume and the lowest pressure; when the amount of the pure water in the water storage tank increases, the volume of the compressed air gradually decreases and the pressure thereof increases, and the back pressure of a reverse osmosis membrane increases accordingly. Because the pressure of tap water varies from place to place, and a certain pressure difference (the pressure difference is equal to the pressure of the reverse osmosis membrane minus the back pressure of the water storage tank) is required for maintaining normal operation of the reverse osmosis membrane. In order to increase the pressure difference, each water purifier manufacturer installs a booster pump in a water purification machine to overcome the back pressure of the water storage tank. However, the booster pump requires associated electrical parts such as a power source, an electromagnetic valve, and a pressure switch; as a result, product costs are increased, and the fault rate is also increased. Besides, when the water storage tank is full of water, the compressed air has the smallest volume and the largest pressure, and the largest water flow is output at the instant the user turns on the water tap. However, as the pure water in the water storage tank gradually decreases, the compressed air gradually expands in volume, the pressure becomes smaller, and an increasingly smaller water flow is output from the water tap, the user has a poor experience in the continuous use of water, and the waiting time of the user is also increased.

In order to solve the problem of the water storage tank, some of manufacturers choose to increase the size (more than 400 gallons per day (GPD)) of a reverse osmosis membrane element and eliminate the water storage tank, that is, the flow obtained when the user turns on the water tap is directly the seepage flow of the reverse osmosis membrane. However, the costs of the large-size reverse osmosis membrane element are increased manyfold, and an associated booster pump of higher power is required, which not only increases product costs but also causes serious noise and vibration problems, thereby lowering the use comfort of the user. Moreover, after the household water purification system stands still for a period of time, the filtration efficiency of the reverse osmosis membrane in the initial operation is low, and at this time, the content of total dissolved solids (TDS) in water flowing out of the water tap is high, resulting in a poor taste. In addition, due to the great influence of water temperature on the seepage flow of the reverse osmosis membrane, that is, the lower the water temperature, the smaller the seepage flow, the pure water machine without a water storage tank has a small water flow output from the water tap in winter with low temperature or in spring and autumn, thereby affecting user experience. Furthermore, the aforementioned reverse osmosis membrane removes almost all ions in drinking water, and many users worry that body health will be affected due to long-term drinking of pure water without any ions.

In view of the above, how to reduce the costs, fault rate, and safety risk of a household water purification system of a reverse osmosis pure water machine and meanwhile improve use comfort of a user is an urgent issue at present.

### SUMMARY

In order to solve at least one of the technical problems existing in the prior art, the present model provides a household water purification system, which not only can reduce equipment costs, fault rate, and safety risk, but also can improve use comfort of a user.

In order to achieve the objective of the present model, a household water purification system is provided, which includes:

a pre-filter, used for performing pre-filtering treatment on tap water; a reverse osmosis membrane filter element, including a water inlet, a pure water outlet, and a non-pure water outlet, where the water inlet of the reverse osmosis membrane filter element is capable of communicating with a water outlet of the pre-filter through a water path; a first one-way valve, having a water inlet communicating with the pure water outlet of the reverse osmosis membrane filter element through a water path; a second one-way valve, having a water inlet communicating with a water outlet of the first one-way valve through a water path; a water storage tank, including a first cavity and a second cavity isolated by a waterproof film, where a total capacity of the two cavities is fixed, and a capacity of the first cavity decreases with increase of a capacity of the second cavity or increases with decrease of the capacity of the second cavity, the first cavity is used for accommodating pure water and separately communicates with the water outlet of the first one-way valve and the water inlet of the second one-way valve through a water path, and the second cavity is used for accommodating tap water treated by the pre-filter; a switching device, used for connecting or disconnecting a water path between the water outlet of the pre-filter and the water inlet of the reverse osmosis membrane filter element according to a change in pressure of the first cavity of the water storage tank; a water tap, having a water inlet communicating with a water outlet of the second one-way valve through a water path; a drainage device, having a water inlet communicating with the non-pure water outlet of the reverse osmosis membrane filter element through a water path; and a mechanical automatic reversing valve, including a first port, a second port, a third port, and a fourth port, where the first port communicates with the water inlet of the water tap through a water path, the second port communicates with the non-pure water outlet of the reverse osmosis membrane filter element through a water path, the third port communicates with the water inlet of the drainage device through a water path, the fourth port communicates with the second cavity of the water storage tank through a water path, and the mechanical automatic reversing valve is used for connecting a water path between the second port and the fourth port and meanwhile disconnecting a water path between the third port and the fourth port according to a change in water pressure at the first port; or disconnecting a water path between the second port and the fourth port and meanwhile connecting a water path between the third port and the fourth port according to a change in water pressure at the first port.

Preferably, when the pressure of the first cavity of the water storage tank decreases to a first threshold, the switching device connects the water path between the water outlet of the pre-filter and the reverse osmosis membrane filter element, while when the pressure of the first cavity of the water storage tank increases to a second threshold, the switching device disconnects the water path between the water outlet of the pre-filter and the reverse osmosis membrane filter element, and the first threshold is less than the second threshold.

Preferably, when the water pressure at the first port decreases to a third threshold, the mechanical automatic reversing valve connects the water path between the second port and the fourth port and meanwhile disconnects the water path between the third port and the fourth port, while when the water pressure at the first port increases to a fourth threshold, the mechanical automatic reversing valve disconnects the water path between the second port and the fourth port and meanwhile connects the water path between the third port and the fourth port, and the third threshold is less than the fourth threshold.

Preferably, the household water purification system further includes a post-filter element having a water inlet communicating with the water outlet of the first one-way valve and the first cavity of the water storage tank through a water path and having a water outlet communicating with the water inlet of the second one-way valve through a water path, or having a water inlet communicating with the water outlet of the second one-way valve through a water path and having a water outlet communicating with the water inlet of the water tap through a water path.

Preferably, the household water purification system further includes a flow limiter having a water inlet communicating with the non-pure water outlet of the reverse osmosis membrane filter element through a water path and having a water outlet communicating with the water inlet of the drainage device through a water path.

Preferably, the flow limiter includes a throttling valve.

According to an embodiment of the present model, the switching device includes a mechanical stop valve, the mechanical stop valve is disposed on the water path between the water outlet of the pre-filter and the water inlet of the reverse osmosis membrane filter element, and a port of the mechanical stop valve communicates with the water outlet of the first one-way valve, the water inlet of the second one-way valve, and the first cavity of the water storage tank through a water path.

According to another embodiment of the present model, the switching device includes an electromagnetic valve, a pressure sensing element, and a control unit, the electromagnetic valve is disposed between the water outlet of the pre-filter and the water inlet of the reverse osmosis membrane filter element; the pressure sensing element is used for detecting the pressure at the first cavity of the water storage tank and sending an electrical signal containing information of the detected pressure to the control unit; and the control unit is used for controlling the electromagnetic valve to connect or disconnect the water path between the water outlet of the pre-filter and the water inlet of the reverse osmosis membrane filter element according to the electrical signal.

According to yet another embodiment of the present model, the water tap includes a first water outlet and a second water outlet, the first water outlet is capable of communicating with the water outlet of the second one-way valve through a water path so that the first water outlet is capable of discharging pure water when the first water outlet is selected to be opened, while the second water outlet communicates with the water outlet of the pre-filter through a water path so that the second water outlet is capable of discharging only water treated by the pre-filter when the second water outlet is selected to be opened.

According to still another embodiment of the present model, the water tap includes a first water inlet, a second water inlet, and a mixing device, the first water inlet communicates with the water outlet of the pre-filter through a water path, the second water inlet communicates with the water outlet of the second one-way valve through a water path, and the mixing device is separately in fluid communication with the first water inlet and the second water inlet and used for mixing non-pure water entering the water tap through the first water inlet and pure water entering the water tap through the second water inlet according to a preset ratio.

Preferably, the number of the pre-filters is one or multiple, and the multiple pre-filters are connected to each other in series. The present model has the following beneficial effects:

As compared with the prior art, the household water purification system provided in the present model has the following advantages:

First, since there is no compressed air in the water storage tank, the space utilization rate of the water storage tank is high, so that the volume of the water storage tank can be reduced, and installation space is saved.

Second, since there is no compressed air in the water storage tank, the influence of back pressure is eliminated when the water tap releases pure water, so that it is not required to provide a booster pump and use electrical power, and the noise, vibration, fault rate, and safety risk of the water purifier are greatly reduced.

Third, when the water tap is turned on, pure water in the first cavity flows out driven by the pressure of non-pure water in the second cavity, so that the flow of pure water is always stable without influence from the change in water temperature.

Fourth, the non-pure water in the second cavity can also be used to flush the reverse osmosis membrane filter element while pressing the pure water in the first cavity, so that the service life of the reverse osmosis membrane filter element can be prolonged.

### BRIEF DESCRIPTION OF THE DRAWINGS

FIG. 1 is a block diagram illustrating the principle of a household water purification system according to a first embodiment of the present model;

FIG. 2 is a schematic structural view of the household water purification system according to the first embodiment of the present model;

FIG. 3 is a schematic structural view of a household water purification system according to a second embodiment of the present model;

FIG. 4 is a schematic structural view of a household water purification system according to a third embodiment of the present model; and

FIG. 5 is a schematic structural view of a household water purification system according to a fourth embodiment of the present model.

### DETAILED DESCRIPTION OF THE EMBODIMENTS

In order to make those skilled in the art understand the technical solution of the present model better, the household water purification system in the present model is described in detail below with reference to the accompanying drawings.

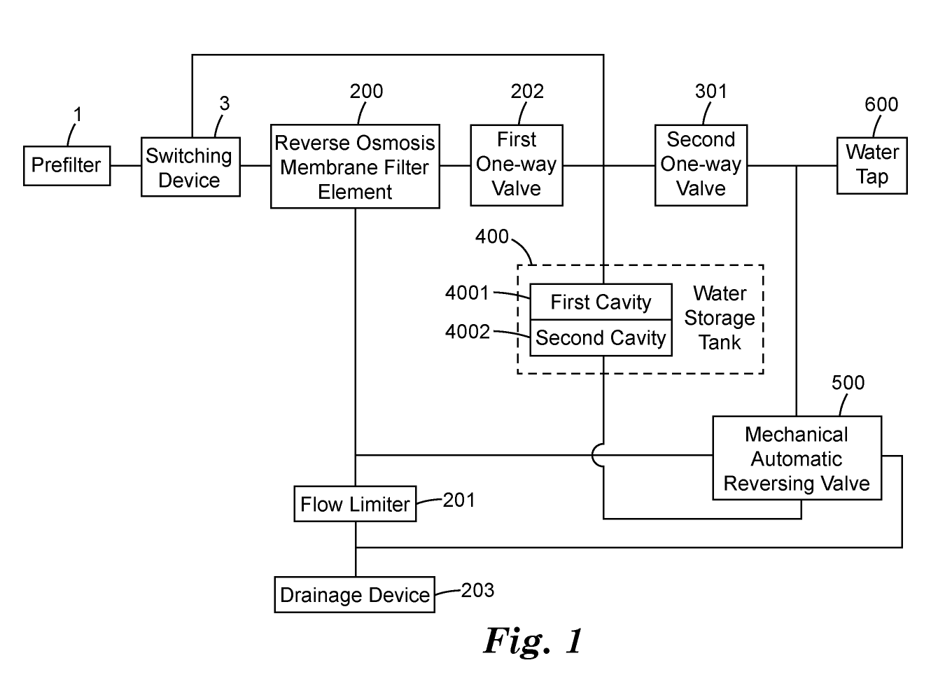

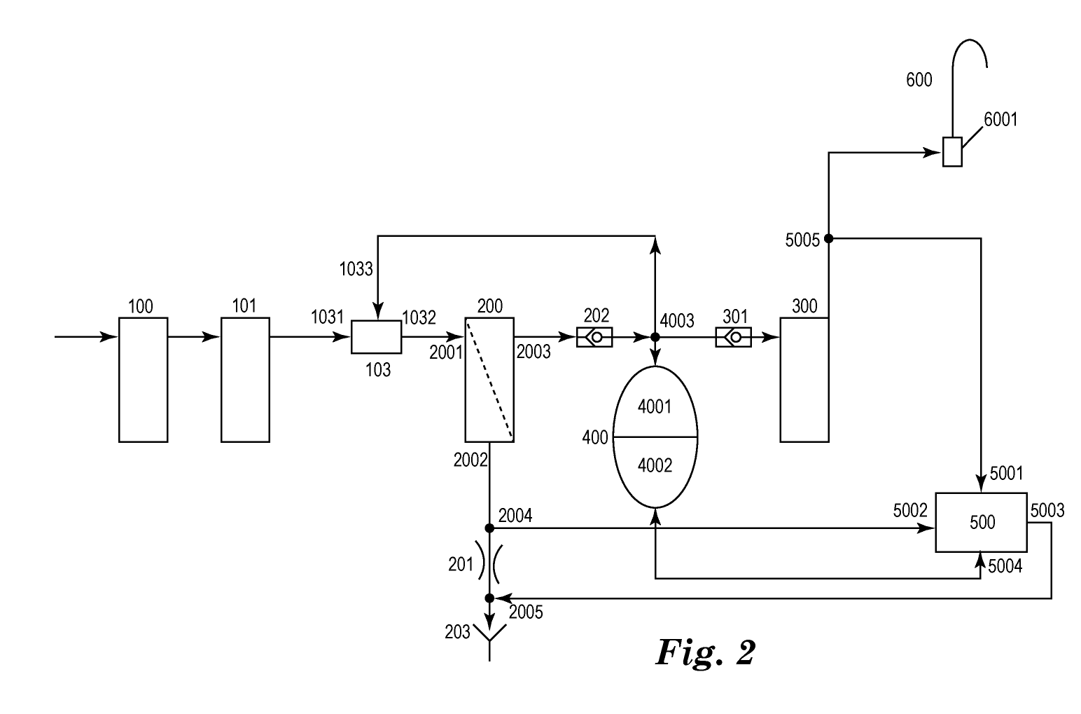

FIG. 1 is a block diagram illustrating the principle of a household water purification system according to a first embodiment of the present model. FIG. 2 is a schematic structural view of the household water purification system according to the first embodiment of the present model. Referring to FIG. 1 and FIG. 2 together, the household water purification system mainly includes a pre-filter 1, a reverse osmosis membrane filter element 200, a first one-way valve 202, a second one-way valve 301, a switching device 3, a water tap 600, a water storage tank 400, a mechanical automatic reversing valve 500, and a drainage device 203. The pre-filter 1 is used for performing preliminary filtering treatment on tap water. In this embodiment, there are two pre-filters 1, which are respectively a first pre-filter 100 and a second pre-filter 101 that are connected in series. Certainly, in actual application, the number of the pre-filters may be selected according to different pre-filtering materials used by the pre-filters, for example, the number may be one or more than three.

The reverse osmosis membrane filter element 200 is used for removing various impurities or contaminants in tap water to finally obtain pure water, and includes a water inlet 2001, a pure water outlet 2003, and a non-pure water outlet 2002. The water inlet 2001 can communicate with a water outlet of the pre-filter 101. Water entering the reverse osmosis membrane filter element 200 through the water inlet 2001 forms pure water after being filtered by a reverse osmosis membrane and flows out through the pure water outlet 2003, while non-pure water not filtered by the reverse osmosis membrane flows out through the non-pure water outlet 2002.

A water inlet of the first one-way valve 202 communicates with the pure water outlet 2003 of the reverse osmosis membrane filter element 200 through a water path, and a water outlet of the first one-way valve 202 communicates with a water inlet of the second one-way valve 301 through a water path. In the present disclosure, a “one-way valve” refers to a valve designed to limit the water flow to flow only in a single direction from a water inlet thereof to a water outlet thereof.

The water storage tank 400 includes a first cavity 4001 and a second cavity 4002 isolated by a waterproof film (for example, an elastic diaphragm), where a total capacity of the two cavities is fixed, and a capacity of the first cavity 4001 decreases with increase of a capacity of the second cavity 4002 or increases with decrease of the capacity of the second cavity 4002. Specifically, with a liquid is filled into the first cavity 4001, the capacity of the first cavity 4001 gradually increases, and meanwhile a liquid in the second cavity 4002 is discharged, and the capacity of the second cavity 4002 decreases accordingly; on the contrary, when a liquid is filled into the second cavity 4002, the capacity of the second cavity 4002 gradually increases, and meanwhile a liquid in the first cavity 4001 is discharged, and the capacity of the first cavity 4001 decreases accordingly. The first cavity 4001 is used for accommodating pure water and separately communicates with the water outlet of the first one-way valve 202 and the water inlet of the second one-way valve 301 at a connection point 4003 through a water path. The second cavity 4002 is used for accommodating tap water (namely, non-pure water) treated by the pre-filter.

The switching device 3 is used for connecting or disconnecting a water path between the water outlet of the pre-filter and the water inlet of the reverse osmosis membrane filter element 200 according to a change in pressure of the first cavity of the water storage tank, so as to connect or disconnect tap water. In this embodiment, the switching device 3 includes a mechanical stop valve 103, and the mechanical stop valve 103 is disposed on the water path between the water outlet of the pre-filter and the water inlet of the reverse osmosis membrane filter element 200. Specifically, as shown in FIG. 1, the mechanical automatic stop valve 103 has three ports, which are respectively a first port 1031, a second port 1032, and a third port 1033, where the first port 1031 is a water inlet and communicates with a water outlet of the second pre-filter 101 through a water path. The second port 1032 is a water outlet and communicates with the water inlet 2001 of the reverse osmosis membrane filter element 200 through a water path. The third port 1033 separately communicates with the water outlet of the first one-way valve 202, the water inlet of the second one-way valve 301, and the first cavity 4001 of the water storage tank 400 at the connection point 4003 through a water path.

As shown in FIG. 2, in this embodiment, a water inlet of the water tap 600 communicates with a water outlet of the second one-way valve 301 through a water path, and the water tap 600 has a single water outlet. In addition, this household water purification system may further include a post-filter element 300. The post-filter element 300 may be, for example, disposed on a water path between the water inlet of the water tap 600 and the water outlet of the second one-way valve 301 as shown in FIG. 2, that is, a water inlet of the post-filter element 300 communicates with the water outlet of the second one-way valve through a water path, a water outlet of the post-filter element 300 communicates with the water inlet of the water tap 600 through a water path, and the post-filter element 300 is located downstream of the second one-way valve 301 and used for further filtering pure water. However, those skilled in the art know that the post-filter element 300 may also be disposed upstream of the second one-way valve 301, that is, the water inlet of the post-filter element 300 communicates with the water outlet of the first one-way valve 202 and the first cavity 4001 of the water storage tank 400 through a water path, and the water outlet of the post-filter element 300 communicates with the water inlet of the second one-way valve 301 through a water path.

In addition, in this embodiment shown in FIG. 2, a water inlet of the drainage device 203 communicates with the non-pure water outlet 2002 of the reverse osmosis membrane filter element 200 through a water path. A flow limiter 201 may also be disposed between the water inlet of the drainage device 203 and the non-pure water outlet 2002 of the reverse osmosis membrane filter element 200. Specifically, as shown in FIG. 2, a water inlet of the flow limiter 201 communicates with the non-pure water outlet 2002 of the reverse osmosis membrane filter element 200 through a water path, and a water outlet of the flow limiter 201 communicates with the water inlet of the drainage device 203 through a water path. The flow limiter 201 is used for producing sufficient acting pressure on the reverse osmosis membrane in the reverse osmosis membrane filter element 200 to ensure that tap water can permeate through the reverse osmosis membrane under the action of the pressure to generate pure water, so as to avoid excessively low flow of pure water caused by insufficient acting pressure. The flow limiter 201 may be a flow limiting element such as a throttling valve.

As shown in FIG. 2, the mechanical automatic reversing valve 500 includes a first port 5001, a second port 5002, a third port 5003, and a fourth port 5004. The first port 5001 communicates with the water inlet of the water tap 600 at a connection point 5005 through a water path; the second port 5002 communicates with the non-pure water outlet 2002 of the reverse osmosis membrane filter element 200 at a connection point 2004 through a water path; the third port 5003 communicates with the water inlet of the drainage device 203 at a connection point 2005 through a water path; and the fourth port 5004 communicates with the second cavity 4002 of the water storage tank 400 through a water path. The mechanical automatic reversing valve 500 is used for connecting a water path between the second port 5002 and the fourth port 5004 and meanwhile disconnecting a water path between the third port 5003 and the fourth port 5004 according to a change in water pressure at the first port 5001, and at this time, a water path between the second cavity 4002 and the non-pure water outlet 2002 of the reverse osmosis membrane filter element 200 is connected, while a water path between the second cavity 4002 and the drainage device 203 is disconnected; or the mechanical automatic reversing valve 500 disconnects a water path between the second port 5002 and the fourth port 5004 and meanwhile connects a water path between the third port 5003 and the fourth port 5004 according to a change in water pressure at the first port 5001, and at this time, the water path between the second cavity 4002 and the non-pure water outlet 2002 of the reverse osmosis membrane filter element 200 is disconnected, while the water path between the second cavity 4002 and the drainage device 203 is connected.

The working process of the household water purification system is described in detail below. Specifically, when the water tap 600 is turned on, the pressure of the water inlet of the water tap 600 decreases, and when the water pressure at the first port of the mechanical automatic reversing valve 500 decreases to a threshold, a spring inside the mechanical automatic reversing valve 500 acts to connect the water path between the second port 5002 and the fourth port 5004 and meanwhile disconnect the water path between the fourth port 5004 and the third port 5003, and at the same time, the pressure in the first cavity 4001 of the water storage tank 400 is released sequentially through the connection point 4003, the second one-way valve 301, the post-filter element 300, and the water tap 600, so that the pressure in the first cavity 4001 decreases. When the pressure in the first cavity 4001 decreases to a threshold, a water path between the water inlet 1031 of the mechanical stop valve 103 and the water outlet 1032 of the mechanical stop valve 103 is connected, tap water sequentially passes through the first pre-filter 100, the second pre-filter 101, and the mechanical stop valve 103, and enters the reverse osmosis membrane filter element 200 through the water inlet 2001 of the reverse osmosis membrane filter element 200, then flows out through the non-pure water outlet 2002 of the reverse osmosis membrane filter element 200, and afterwards, enters the second cavity 4002 of the water storage tank 400 through the connection point 2004, and the second port 5002 and the fourth port 5004 of the mechanical reversing valve 500, so as to push pure water in the first cavity 4001 to sequentially pass through the connection point 4003, the second one-way valve 301, and the post-filter element 300 and finally flow out from the water tap 600.

When the water tap 600 is turned off, since the water path between the water inlet 1031 and the water outlet 1032 of the mechanical stop valve 103 is still in the connected state, the water pressure of the water inlet of the water tap 600 rises rapidly in a short time, and the water pressure at the first port 5001 of the mechanical automatic reversing valve 500 also rises rapidly in a short time, and when the water pressure at the first port 5001 increases to a threshold, the spring inside the mechanical reversing valve 500 is pushed to act to disconnect the water path between the second port 5002 and the fourth port 5004 and meanwhile connect the water path between the second port 5002 and the third port 5003, so as to connect the water path between the second cavity 4002 and the drainage component 203, so that the pressure of the second cavity 4002 is released in a short time; at the same time, the pressure of the first cavity 4001 and on the connection point 4003 is also released rapidly. At this time, the pressure of the water path between the water outlet of the second one-way valve 301 and the water tap 600 is maintained at a certain value due to the protection of the second one-way valve 301, so as to maintain the mechanical automatic reversing valve 500 at a certain position through the water path between the connection point 5005 and the first port 5001 of the mechanical reversing valve 500, so as to ensure that the water path between the second port 5002 and the fourth port 5004 remains in the disconnected state, while the water path between the fourth port 5004 and the third port 5003 remains in the connected state. Since the pressure of the first cavity 4001 and on the connection point 4003 is quite low, and the water path between the water inlet 1031 and the water outlet 1032 of the mechanical stop valve 103 is still in the connected state, tap water entering the reverse osmosis membrane filter element 200 through the water inlet 2001 of the reverse osmosis membrane filter element 200 permeates through the reverse osmosis membrane in the reverse osmosis membrane filter element 200 under the action of the pressure to form pure water, and flows out through the pure water outlet 2003 of the reverse osmosis membrane filter element 200, and then enters the first cavity 4001 sequentially through the first one-way valve 202 and the connection point 4003, while non-pure water originally in the second cavity 4002 is discharged through the fourth port 5004 and the third port 5003 of the mechanical reversing valve 500 and the drainage device 203 under the pressing of the first cavity 4001.

In the process that the capacity of the first cavity 4001 gradually increases, the pressure of the connection point 4003 remains at an extremely low value so as to ensure that tap water in the reverse osmosis membrane filter element 200 can permeate through the reverse osmosis membrane in the reverse osmosis membrane filter element 200 under the action of the pressure, thereby ensuring production of enough pure water flow.

When the first cavity 4001 is completely filled up and meanwhile non-pure water in the second cavity 4002 is completely drained, the pure water storage amount in the water storage tank 400 cannot be further increased, and driven by the pressure of the tap water, the pressure in the water storage tank 400 begins to gradually rise and the pressure at the connection point 4003 also begins to rise. When the pressure value increases to a threshold, the water path between the first port 1031 and the second port 1032 of the mechanical stop valve 103 is disconnected, and the entire household water purification system stops working.

It should be noted that the function of the first one-way valve 202 lies in: when the water tap 600 is turned on, the first one-way valve 202 is used for stopping pure water in the first cavity 4001 of the water storage tank 400 from flowing back to the reverse osmosis membrane filter element 200 to ensure that the pure water can flow out from the water tap 600; and when the water tap 600 is turned off and the system replenishes pure water into the first cavity 4001 of the water storage tank 400, the first one-way valve 202 does not stop pure water from flowing toward the first cavity 4001 of the water storage tank 400 from the reverse osmosis membrane filter element 200.

The function of the second one-way valve 301 lies in: when the water tap 600 is turned off, water in the water path between the water outlet of the second one-way valve 301 and the water inlet of the water tap 600 neither can be discharged from the water tap 600 nor can flow back from the water outlet of the second one-way valve 301, so that the water pressure between the water outlet of the second one-way valve 301 and the water inlet of the water tap 600 is maintained at a certain value, and then the spring inside the mechanical automatic reversing valve 500 can remain at the current position, so as to ensure that the second port 5002 and the fourth port 5004 are disconnected, while the fourth port 5002 and the third port 5003 are connected, and ensure that the water storage tank 400 has no back pressure.

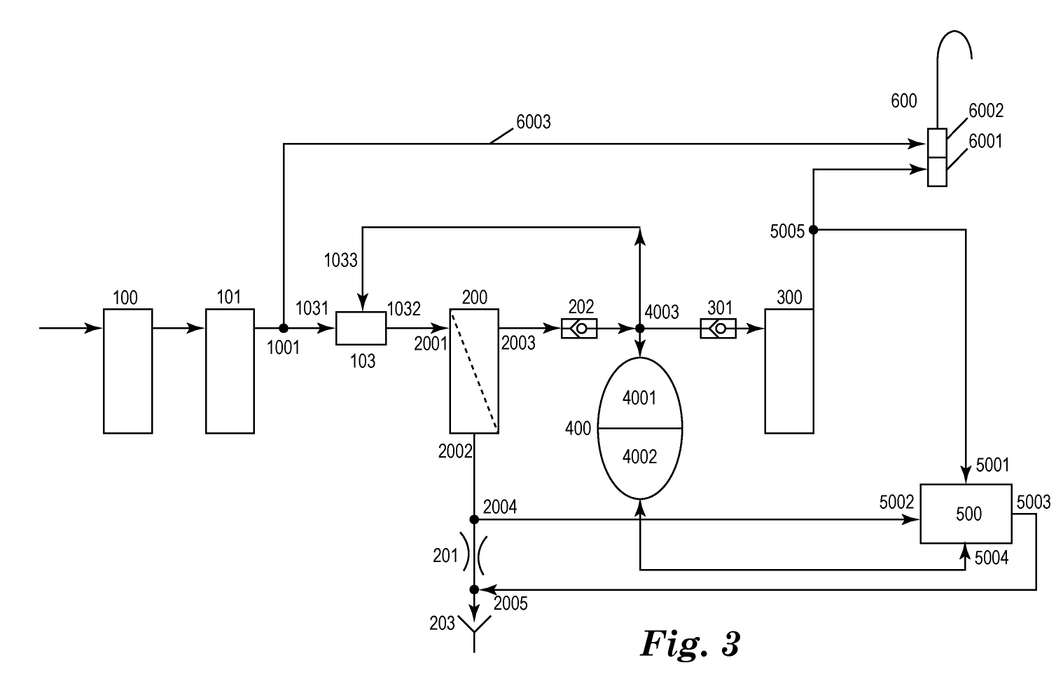

FIG. 3 is a schematic structural view of a household water purification system according to a second embodiment of the present model. As shown in FIG. 3, the household water purification system provided in this embodiment differs from the first embodiment only in that: the household water purification system provided in this embodiment adopts a water tap having two water outlets.

Specifically, the household water purification system further includes a non-pure water path 6003, and the water tap 600 includes a first water outlet 6001 and a second water outlet 6002, where the first water outlet 6001 communicates with the water outlet of the second one-way valve 301 through a water path so that the first water outlet 6001 can discharge pure water when first water outlet 6001 is selected to be opened. The second water outlet 6002 is connected to the water outlet of the second pre-filter 101 at a connection point 1001 through the non-pure water path 6003 so that the second water outlet 6002 can discharge only non-pure water treated by the pre-filter when the second water outlet 6002 is selected to be opened.

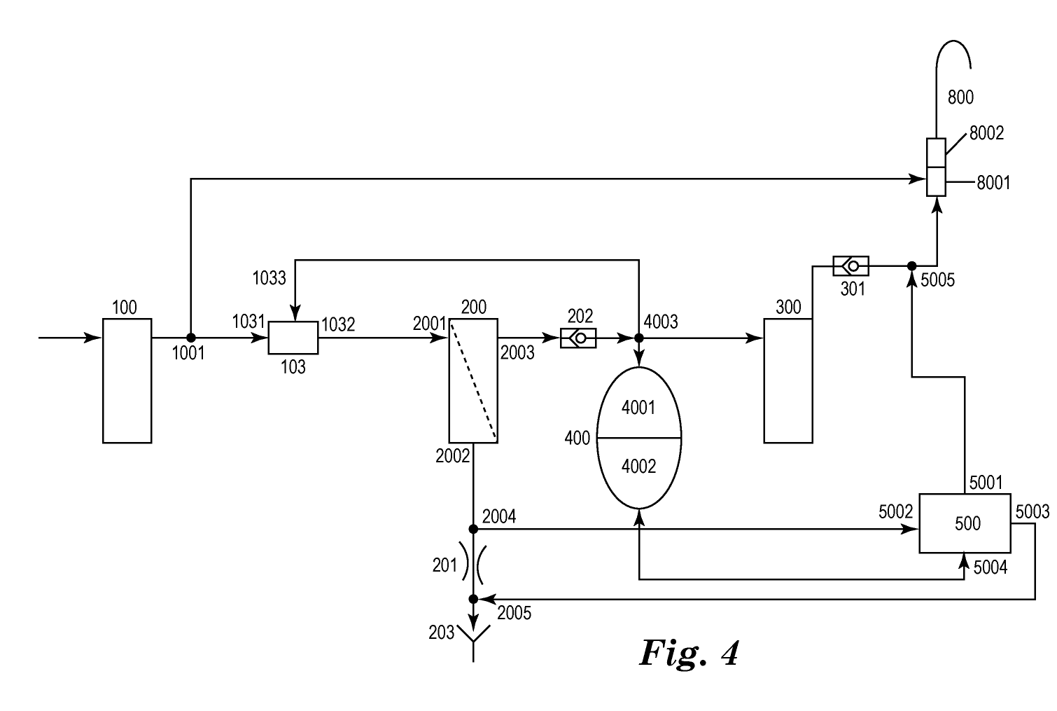

FIG. 4 is a schematic structural view of a household water purification system according to a third embodiment of the present model. Referring to FIG. 4, the household water purification system provided in this embodiment differs from the first embodiment only in that: there is one pre-filter, namely, the pre-filter 100. Meanwhile, a water tap 800 includes a first water inlet, a second water inlet, a mixing device 8001, and a switch 8002. The first water inlet is connected to the connection point 1001 through a water path and communicates with the water outlet of the pre-filter 100, so that tap water treated by the pre-filter 100 can enter the water tap 800 through the first water inlet. The second water inlet communicates with the water outlet of the second one-way valve 301 through a water path, so that pure water can enter the water tap 800 through the second water inlet. The mixing device 8001 can mix water entering the water tap 800 through the first water inlet and pure water entering the water tap 80 through the second water inlet according to a predetermined ratio, eventually enabling the mixed water to be discharged from the water outlet of the water tap 800. 8002 denotes the switch on the water tap 800 and is used for turning on or off water output of the water tap 800. The mixing device 8001 may be disposed separately from or in combination with the switch 8002.

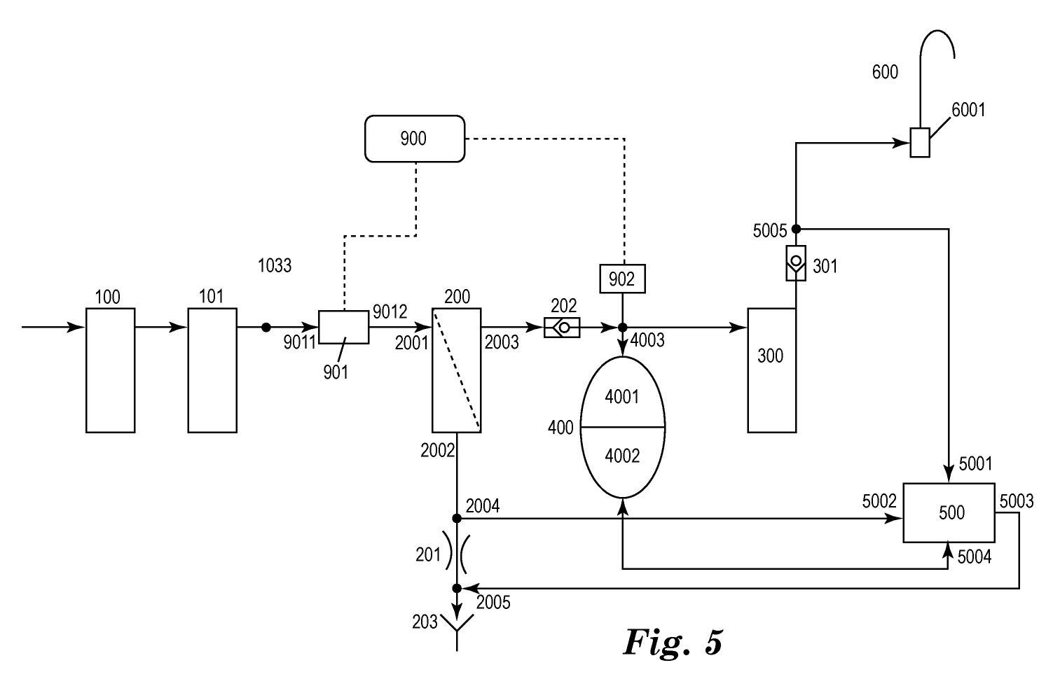

FIG. 5 is a schematic structural view of a household water purification system provided according to a fourth embodiment of the present model. FIG. 5 shows an embodiment employing an electrical switching system to replace the mechanical automatic stop valve 103 in the aforementioned embodiments. As shown in FIG. 5, the electrical switching system mainly includes an electromagnetic valve 901, a pressure sensing element 902, and a control unit 900. The electromagnetic valve 901 is installed between the water outlet of the pre-filter 101 and the water inlet of the reverse osmosis membrane filter element (specifically, as shown in FIG. 5, a water inlet 9011 of the electromagnetic valve 901 communicates with the water outlet of the pre-filter 101 through a water path, and a water outlet 9012 of the electromagnetic valve 901 communicates with the water inlet 2001 of the reverse osmosis membrane filter element 200 through a water path), and a water path of the pressure sensing element 902 is installed on the connection point 4003 and used for detecting the pressure of the first cavity 4001 of the water storage tank 400. The electromagnetic valve 901 and the pressure sensing element 902 are connected to the control unit 900 through electrical connection lines denoted by dotted lines. The control unit 900 is used for providing power to the electromagnetic valve 901 and the pressure sensing element 902 and meanwhile can turn on or off the electromagnetic valve 902 according to a signal provided by the pressure sensing element 902, thereby realizing connection or disconnection of the water path between the water outlet of the pre-filter 101 and the water inlet of the reverse osmosis membrane filter element 200.

The household water purification system in the present model is described above with reference to the accompanying drawings and the specific embodiments.

Generally speaking, as compared with the prior art, the household water purification system according to each of the aforementioned embodiments of the present model has the following advantages:

First, since there is no compressed air in the water storage tank 400, the space utilization rate of the water storage tank is high, so that the volume of the water storage tank 400 can be reduced, and installation space is saved.

Second, since there is no compressed air in the water storage tank 400, there is no back pressure when the water tap 600 releases pure water, so that it is not required to provide a booster pump and use electrical power, and the noise, vibration, fault rate, and safety risk of the water purification system are greatly reduced.

Third, when the water tap 600 is turned on, pure water in the first cavity 4001 flows out driven by the pressure of non-pure water in the second cavity 4002, so that the flow of pure water is always stable, unlike an existing reverse osmosis pure water machine whose flow will be affected by the air pressure attenuation in the water storage tank thereof and the change in water temperature.

Fourth, the non-pure water in the second cavity 4002 can also be used to flush the reverse osmosis membrane filter element 200 while pressing the pure water in the first cavity 4001 to make it flow out from the water tap, so that the service life of the reverse osmosis membrane filter element can be prolonged.

Although the present model has been described with reference to the aforementioned embodiments, it can be understood that the aforementioned embodiments are merely exemplary embodiments adopted for describing the principle of the present model. The present model is not limited to these embodiments. Those skilled in the art can make various transformations and improvements to these embodiments without departing from the spirit and essence of the present model, and these transformations and improvements also fall within the protection scope of the present model.

1. A household water purification system, comprising:
a pre-filter, used for performing pre-filtering treatment on tap water;
a reverse osmosis membrane filter element, comprising a water inlet, a pure water outlet, and a non-pure water outlet, wherein the water inlet of the reverse osmosis membrane filter element is capable of communicating with a water outlet of the pre-filter through a water path;
a first one-way valve, having a water inlet communicating with the pure water outlet of the reverse osmosis membrane filter element through a water path;
a second one-way valve, having a water inlet communicating with a water outlet of the first one-way valve through a water path;
a water storage tank, comprising a first cavity and a second cavity isolated by a waterproof film, wherein a total capacity of the two cavities is fixed, and a capacity of the first cavity decreases with increase of a capacity of the second cavity or increases with decrease of the capacity of the second cavity, the first cavity is used for accommodating pure water and separately communicates with the water outlet of the first one-way valve and the water inlet of the second one-way valve through a water path, and the second cavity is used for accommodating tap water treated by the pre-filter;
a switching device, used for connecting or disconnecting a water path between the water outlet of the pre-filter and the water inlet of the reverse osmosis membrane filter element according to a change in pressure of the first cavity of the water storage tank;
a water tap, having a water inlet communicating with a water outlet of the second one-way valve through a water path;
a drainage device, having a water inlet communicating with the non-pure water outlet of the reverse osmosis membrane filter element through a water path; and
a mechanical automatic reversing valve, comprising a first port, a second port, a third port, and a fourth port, wherein the first port communicates with the water inlet of the water tap through a water path, the second port communicates with the non-pure water outlet of the reverse osmosis membrane filter element through a water path, the third port communicates with the water inlet of the drainage device through a water path, the fourth port communicates with the second cavity of the water storage tank through a water path, and the mechanical automatic reversing valve is used for connecting a water path between the second port and the fourth port and meanwhile disconnecting a water path between the third port and the fourth port according to a change in water pressure at the first port, or disconnecting a water path between the second port and the fourth port and meanwhile connecting a water path between the third port and the fourth port according to a change in water pressure at the first port.

2. The household water purification system according to claim 1, wherein when the pressure of the first cavity of the water storage tank decreases to a first threshold, the switching device connects the water path between the water outlet of the pre-filter and the reverse osmosis membrane filter element, while when the pressure of the first cavity of the water storage tank increases to a second threshold, the switching device disconnects the water path between the water outlet of the pre-filter and the reverse osmosis membrane filter element, and the first threshold is less than the second threshold.

3. The household water purification system according to claim 1, wherein when the water pressure at the first port decreases to a third threshold, the mechanical automatic reversing valve connects the water path between the second port and the fourth port and meanwhile disconnects the water path between the third port and the fourth port, while when the water pressure at the first port increases to a fourth threshold, the mechanical automatic reversing valve disconnects the water path between the second port and the fourth port and meanwhile connects the water path between the third port and the fourth port, and the third threshold is less than the fourth threshold.

4. The household water purification system according to claim 1, further comprising a post-filter element having a water inlet communicating with the water outlet of the first one-way valve and the first cavity of the water storage tank through a water path and having a water outlet communicating with the water inlet of the second one-way valve through a water path, or having a water inlet communicating with the water outlet of the second one-way valve through a water path and having a water outlet communicating with the water inlet of the water tap through a water path.

5. The household water purification system according to claim 1, further comprising a flow limiter having a water inlet communicating with the non-pure water outlet of the reverse osmosis membrane filter element through a water path and having a water outlet communicating with the water inlet of the drainage device through a water path.

6. The household water purification system according to claim 5, wherein the flow limiter comprises a throttling valve.

7. The household water purification system according to claim 1, wherein the switching device comprises a mechanical stop valve, the mechanical stop valve is disposed on the water path between the water outlet of the pre-filter and the water inlet of the reverse osmosis membrane filter element, and a port of the mechanical stop valve communicates with the water outlet of the first one-way valve, the water inlet of the second one-way valve, and the first cavity of the water storage tank through a water path.

8. The household water purification system according to claim 1, wherein the switching device comprises an electromagnetic valve, a pressure sensing element, and a control unit, the electromagnetic valve is disposed between the water outlet of the pre-filter and the water inlet of the reverse osmosis membrane filter element; the pressure sensing element is used for detecting the pressure at the first cavity of the water storage tank and sending an electrical signal containing information of the detected pressure to the control unit; and the control unit is used for controlling the electromagnetic valve to connect or disconnect the water path between the water outlet of the pre-filter and the water inlet of the reverse osmosis membrane filter element according to the electrical signal.

9. The household water purification system according to claim 1, wherein the water tap comprises a first water outlet and a second water outlet, the first water outlet communicates with the water outlet of the second one-way valve through a water path so that the first water outlet is capable of discharging pure water when the first water outlet is selected to be opened, while the second water outlet communicates with the water outlet of the pre-filter through a water path so that the second water outlet is capable of discharging only water treated by the pre-filter when the second water outlet is selected to be opened.

10. The household water purification system according to claim 1, wherein the water tap comprises a first water inlet, a second water inlet, and a mixing device, the first water inlet communicates with the water outlet of the pre-filter through a water path, the second water inlet communicates with the water outlet of the second one-way valve through a water path, and the mixing device is separately in fluid communication with the first water inlet and the second water inlet and used for mixing non-pure water entering the water tap through the first water inlet and pure water entering the water tap through the second water inlet according to a preset ratio.

11. The household water purification system according to claim 1, wherein the number of the pre-filters is one or multiple, and the multiple pre-filters are connected to each other in series.
